(19) United States
(12) Patent Application Publication
(10) Pub. No.: US 2009/0237823 A1
(43) Pub. Date: Sep. 24, 2009

(54) MAGNETIC TRANSFER METHOD FOR MAGNETIC RECORDING MEDIUM, AND MAGNETIC RECORDING MEDIUM

(75) Inventor: Naoto FUJIWARA, Odawara-Shi (JP)

Correspondence Address: YOUNG & THOMPSON, 209 Madison Street, Suite 500, ALEXANDRIA, VA, 22314, US

(73) Assignee: FUJIFILM CORPORATION, Tokyo (JP)

(21) Appl. No.: 12/409,777

(22) Filed: Mar. 24, 2009

(30) Foreign Application Priority Data
Mar. 24, 2008 (JP) 2008-076668

(51) Int. Cl. G11B 5/86

(52) U.S. Cl. 360/17; G9B/5.308

(57) ABSTRACT

A magnetic transfer method including initially magnetizing a perpendicular magnetic recording medium by applying a DC magnetic field thereto in a perpendicular direction, and applying, to the perpendicular magnetic recording medium, a DC magnetic field for 100 nsec to 1 sec in an opposite direction to the magnetic field applied in initial magnetization with the recording medium being closely attached to a magnetic transfer master carrier which transfers magnetic information to the recording medium with being brought into contact with the recording medium, wherein the master carrier includes transfer portions on which surfaces a magnetic layer corresponding to magnetic information is laid, and non-transfer portions which are concave portions lower in height than the transfer portions, and wherein the magnetic layer has perpendicular magnetic anisotropy and has a residual magnetization Mr of 500 emu/cc or lower and a saturation magnetization Ms of 900 emu/cc or higher.

### BACKGROUND OF THE INVENTION

1. Field of the Invention

The present invention relates to a magnetic transfer method for a magnetic recording medium, in which method magnetic information (e.g., servo information) is magnetically transferred to a perpendicular magnetic recording medium in which recorded magnetization is in a perpendicular direction to the medium surface; and a magnetic recording medium obtained by the magnetic transfer method.

2. Description of the Related Art

In recent years, magnetic recording/reproducing devices have attained higher recording density so as to realize large capacity and downsizing thereof. In particular, advancement in the field of hard disc drives (HDDs), which are a typical magnetic recording device, has been drastically made.

In view that a quantity of information recorded/reproduced becomes large, demand has arisen for a high-density magnetic recording medium which has a large capacity (i.e., can record a volume of information), which is inexpensive, and in which so-called high-speed access is preferably realized (i.e., required information can be read in a short time). The high-density magnetic recording medium has an information recording area composed of narrow tracks. A so-called tracking servo technique has an important role in enabling the recording medium to reproduce signals at a high S/N ratio by accurately moving a magnetic head in narrow track widths for scanning. For carrying out the tracking servo, a sector servo method is widely employed.

The sector servo method is a method in which a magnetic head scans servo fields to read servo information, and is adjusted in position while confirming its position depending on the servo information. Here, the servo fields are orderly arranged at a certain angle on the data surface of a magnetic recording medium (e.g., magnetic disc) and record servo information such as servo signals for positioning on a track, address information signals of the track, and reproduction clock signals.

The servo information is required to be previously recorded in a magnetic recording medium as a preformat during production thereof. Currently, the preformat is formed with a specialized servo recording device. In one currently used servo recording device, while a magnetic disc is rotated with being disposed proximately to a magnetic head with a width about 75% of a track pitch, the magnetic head is moved from the outer circumference to the inner circumference of the magnetic disc every ½ tracks for recording of servo signals. Thus, it takes a long time to complete preformat recording for one magnetic disc, resulting in causing a drop in production efficiency, and cost elevation.

In order to accurately and efficiently carry out preformat recording, there has been proposed a method in which information of a master recording medium having a pattern corresponding to servo information is magnetically transferred to a magnetic recording medium (see Japanese Patent Application Laid-Open (JP-A) Nos. 2003-203325 and 2000-195048, U.S. Pat. No. 7,218,465 B1, and JP-A Nos. 2004-12142 and 2001-297435).

In this magnetic transfer, a recording magnetic field is applied while a master carrier having a magnetic layer with a pattern corresponding to information (e.g., servo information) to be transferred to a magnetic recording medium (slave medium) (e.g., a magnetic disc for transfer) is closely attached to a magnetic recording medium (slave medium), to thereby magnetically transfer, to the magnetic recording medium, a magnetic pattern corresponding to the pattern of the magnetic layer of the master carrier. This method is advantageous in that it can statically record information without relatively changing the position of the master carrier and the position of the magnetic recording medium, can accurately record preformat information, and can record information in a very short time.

JP-A No. 2004-12142 discloses a magnetic transfer technique based on in-plane magnetic recording in which a magnetization to be recorded is in parallel with the medium surface. JP-A No. 2001-297435 discloses a magnetic transfer technique based on perpendicular magnetic recording in which a magnetization to be recorded is perpendicular to the medium surface.

Perpendicular magnetic recording can be expected to be remarkably improved in recording density as compared with in-plane magnetic recording. Thus, in order to meet the recent requirements for an increase in recording density, development of the perpendicular magnetic recording technique has been continued, and the perpendicular magnetic recording medium is practically used.

Magnetic transfer for a perpendicular magnetic recording medium is carried out as follows. First, a DC magnetic field is applied onto a perpendicular magnetic recording medium (slave disc), to which information is to be transferred, in a perpendicular direction to the disc surface, to thereby initially magnetize a magnetic layer (recording layer) of the disc. After the initial magnetization, an original master for transfer (master disc) is closely attached to the slave disc. In this state, a DC magnetic field is applied in an opposite direction to the initial magnetization, to thereby transfer, to the slave disc, information corresponding to a concavo-convex pattern formed in the surface of the original master for transfer.

Although the quality of a transfer signal depends greatly on the conditions under which a magnetic field is applied during transfer, conventionally, sufficient investigation has not been made on the relationship between the application time of a magnetic field and the quality of a transfer signal. Notably, JP-A No. 2004-12142 difines, in relation to in-plane magnetic recording, the intensity of a DC magnetic field applied after initial magnetization in an opposite direction thereto, but does not refer to the application time of a magnetic field.

In accordance with an increase in magnetic recording density, high-density (short-bit) recording is demanded also in magnetic transfer. As the bit becomes shorter, a magnetic field becomes weaker in a convex portion participating in transfer. In addition, the difference in magnetic field decreases between the convex and concave portions, resulting in reducing the difference between the magnetization quantity brought by the magnetic field in the concave portion and that brought by the magnetic field in the convex portion. Furthermore, larger spacing loss is observed in shorter bits and thus, magnetic transfer is difficult to carry out satisfactorily. In view of this, there is a need to develop a new technique.

FIG. 1 is a simulation graph showing a situation where a slave medium is more insufficiently magnetized as the bit length becomes shorter. The horizontal axis corresponds to a bit length and the vertical axis corresponds to a value ΔMz/Ms; i.e., a value by normalizing ΔMz by a saturation magnetization Ms. Here, ΔMz is obtained by subtracting Mz 1 from Mz 2, where Mz 1 denotes an intensity of an initial magnetization (negative value) and Mz 2 denotes an intensity of a magnetization after transfer (i.e., inverted magnetization) (positive value); i.e., ΔMz is a change in magnetization of the slave medium having undergone transfer. Ideally, when the initial magnetization is—Ms and a magnetization after transfer is Ms, ΔMz/Ms is the maximum value 2, which means that a magnetic layer of the magnetic disc exhibits its performance to the greatest extent.

As is clear from FIG. 1, the value ΔMz/Ms decreases as the bit length becomes shorter. When the bit length is 50 nm, the value ΔMz/Ms is 0.8, which is about 40% of the maximum value 2. That is, only 40% of the performance of the magnetic layer can be utilized, which means that the magnetic recording layer cannot sufficiently exhibit its performance. In this point, there is a demand to realize satisfactory transfer even in use of a short-bit medium.

Conventionally, in many cases, a magnetic layer of the master carrier has been made of an isotropic soft magnetic material (having no magnetic anisotropy). In general, a soft magnetic layer contained in the master carrier preferably has a high saturation magnetization Ms. Thus, conventionally, Fe₇Co₃, etc. have been used for forming a magnetic layer of the master carrier (master magnetic layer). Also, paragraph [0006] of JP-A No. 2003-203325 describes that the master magnetic layer preferably has higher saturation magnetization Ms.

However, the master magnetic layer having higher saturation magnetization Ms poses the following problem. Specifically, when the master carrier contains a magnetic layer having high saturation magnetization Ms, a demagnetic field (4π×Ms in a plane) becomes large, resulting in that only part of a magnetic field applied contributes to magnetization.

The intensity of the demagnetic field depends on the shape of a magnetic material (relationship among dimensions thereof). FIG. 2 is a graph of a magnetic field applied vs. a magnetization. This graph is obtained by applying a magnetic field to a block of a master carrier in a depth direction, the block measuring 2 (in a radial direction)×0.5 (in a circumference direction)×0.5 (in a depth direction) (note that these values may have any units).

Taking for example the case where magnetic transfer is carried out on a slave disc having a coercive force He=4,000 Oe, as shown in FIG. 2, the master magnetic layer (Fe₇Co₃ in FIG. 2) has a magnetization of about 950 emu/cc under application of a magnetic field Ha of 5,000 Oe. This indicates that Fe₇Co₃ exhibits only about 50% of its performance, since Fe₇Co₃ has a saturation magnetization Ms of 1,900 emu/cc. This is due to formation of a demagnetic field in which a magnetic material is difficult to magnetize as a result of formation of a magnetic field in an opposite direction by an external magnetic field. That is, as shown in FIG. 2, the master magnetic layer has a magnetization of about 950 emu/cc under application of 5,000 Oe and thus, a magnetization oriented at an initial magnetization step cannot be inverted when a slave medium has high coercive force He.

As the transfer magnetic field Ha is increased, the magnetization quantity is increased in a portion which is in contact with the slave medium (i.e., a convex portion of the master). But, a large quantity of the magnetic field is leaked to the concave portion of the master carrier (which portion corresponds to a portion of the slave medium where initial magnetization is to be maintained); i.e., the intensity of the initial magnetization is considerably decreased, leading to problematic degradation of the S/N ratio of a transfer signal. In view of the above, conventionally, a magnetic field having an intensity of about the coercive force Hc of a slave medium for magnetic transfer so as to maximize the difference in magnetization between the convex and concave portions. Also in this case, a considerable amount of the magnetic field is leaked to the concave portion due to a demagnetic field, degrading the intensity of the initial magnetization thereof.

Also, in perpendicular magnetic transfer, a magnetic field in the concave portion of the master (i.e., an interbit portion which is not contact with a magnetic layer of the slave medium) is moved to the convex portion for magnetic transfer. When the interbit distance becomes shorter in accordance with an increase in recording density, a magnetic field which can be utilized is decreased, and larger spacing loss is observed. Thus, a conventional magnetic layer cannot satisfy the requirements for magnetic transfer on a short-bit medium.

Meanwhile, JP-A No. 2000-195048 describes that a perpendicularly magnetized film having perpendicular magnetic anisotropy is preferably used as a master magnetic layer for use in perpendicular magnetic recording (see paragraph [0037] of JP-A No. 2000-195048), but does not disclose required characteristic values of the film. Various studies have been made on a perpendicular magnetic anisotropic film in accordance with development of a magnetic recording medium. These studies are not about a magnetic film used in a master carrier, but about a perpendicularly magnetized film used for magnetic recording The physical characteristics required for a magnetic film used in a perpendicular magnetic recording medium are quite different from those required for a magnetic film used in a master magnetic layer. Thus, even if a conventionally studied perpendicularly magnetized film used in a magnetic recording medium is used as is as a master magnetic layer, magnetic transfer cannot be satisfactorily carried out.

FIG. 3 is a graph of a typical M-H curve (hysteresis curve) of a perpendicular magnetic recording medium, wherein only the first and fourth quadrants are given. In FIG. 3, the horizontal axis corresponds to an external magnetic field applied, and the vertical axis corresponds to a magnetization normalized by a saturation magnetization Ms. The perpendicular magnetic recording medium giving the graph has a low saturation magnetization Ms; i.e., about 400 emu/cc, and a high coercive force He; i.e., 5,000 Oe. Also, the squareness ratio SQ (−Mr/Ms) is 1. Such characteristics are required for the following reasons. Specifically, after a magnetic film for use in a perpendicular magnetic recording medium has been subjected to information recording with a magnetic head, the magnetic film must retain recorded information even under no application of a magnetic field. Thus, the squareness ratio SQ is required to be 1. Also, in high-density recording, the coercive force He is required to be high for improving linearity of the transition region. Meanwhile, the saturation magnetization Ms is preferably higher, but a material with low Ms is actually used. This is because a high-Ms material is not necessarily required to be used in accordance with an increase in sensitivity of a reproducing head (MR head), and there has not been found a material which has high Ms, which has small interaction among magnetization units, and which satisfies SQ=1 or a production method for the material

When a magnetic layer giving an M-H curve shown in FIG. 3 was experimentally used as a magnetic layer of a master carrier, a transfer pattern could not sharply be transferred. Presumably, the reason for this is as follows. That is, a transfer magnetic field is not sufficient since the saturation magnetization Ms of the layer is low; and part of the slave medium is unnecessarily magnetized with a magnetic field generated by the magnetization of the master remaining after decrease in a magnetic filed applied, since the magnetic layer has a high coercive force Hc and a squareness ratio SQ of 1.

As described above, it has been found that a perpendicularly magnetized film for use in a magnetic recording medium is not preferably used as a magnetic layer of a master carrier.

U.S. Pat. No. 7,218,465 B1 discloses a master carrier whose concave portions are embedded with permanently magnetizable films having perpendicular magnetic anisotropy. The content of U.S. Pat. No. 7,218,465 B1 is not sufficient for realizing transfer on a short-bit medium. Next will be four reasons for this. First, U.S. Pat. No. 7,218,465 B1 does not describe effective characteristics of a perpendicular magnetic anisotropic film. In lines 58 to 60, column 4 of U.S. Pat. No. 7,218,465 B1, the conditions that saturation magnetization Bsat≧about 0.5 T and magnetic permeability μ≧ about 5 are given as magnetic characteristics of a magnetic material. But, even when Bsat≧about 0.5 T, satisfactory transfer cannot be carried out due to a demagnetic field as described above. Also, regarding the master carrier, it is already known that the condition μ≧100 is sufficient (μ is preferably higher), which is not a newly presented condition.

Second, U.S. Pat. No. 7,218,465 B1 describes that the material of a magnetic film is selected from Ni, NiFe, CoNiFe, CoSiFe, CoFe and CoFeV. But, these materials could not exhibit below-described characteristics in the present invention and thus, could not exhibit satisfactory transfer characteristics.

Third, in the master carrier disclosed in U.S. Pat. No. 7,218,465 B1, as shown in FIG. 4, the concave portion of a master carrier 300 is embedded with a magnetic layer 304, and a surface of the master carrier 300 which surface is to be in contact with a slave for transfer is a flat surface. It is difficult that a flat large surface of the master is closely attached to a flat large surface of the slave. In particular, larger spacing loss is observed in shorter bits and thus, such a magnetic layer-embedded master carrier is not suitable since the contact area of it with the slave becomes large.

In addition, when the master and the slave that have been closely attached to each other are separated from each other, the separation is difficult to carry out to adversely affect mass-production suitability. This is because, the contact area is large to increase adhesive force between the master and slave, magnetic binding force (both positive force and negative force), and binding force between the bits and master; i.e., the contact area becomes about twice an area where a concavo-convex master is closely attached to a slave, resulting in that these forces are also about twice.

Fourth, when the slave and master are separated from each other after transfer, they unavoidably slide against each other in a radial direction of the discs. Thus, when a permanently magnetizable film is used, the slave may be modified by the action of the magnetic field generated from the master, problematically degrading an SIN ratio.

The technique disclosed in JP-A No. 2003-203325 is not suitable for transfer on a short-bit medium for the following reasons. Specifically, JP-A No. 2003-203325 discloses a technique of preventing undesirable spread of transfer pattern, in which two perpendicular ferromagnetic films are used as a magnetic layer of a master carrier, and the magnetic flux of one magnetic bit is in an opposite direction to that of another magnetic bit However, only a material having low saturation magnetization Ms can be actually applied to this technique, and TbFeCo and TbFe exemplified in JP-A No 2003-203325 have an Ms of as low as 40 emu/cc and an Ms of as low as 300 emu/cc, respectively. Thus, these cannot be satisfactorily used in a high-density recording medium which is required to have a coercive force Hc of 4,000 Oe or higher.

In addition, the master carrier disclosed in JP-A No 2003-203325 requires, as a magnetic layer, two different layers made of two different materials and thus, involves complicated production process. Furthermore, similar to the magnetic layer-embedded master carrier (shown in FIG. 2) disclosed in U.S. Pat. No. 7,218,465 B1, the master medium disclosed in JP-A No. 2003-203325 has an entirely flat transfer surface. Thus, as described above, it is difficult for the flat surface to entirely come into close contact with a flat surface of the slave medium so as to attain information recording on a short-bit medium. Also, similar to U.S. Pat. No. 7,218,465 B1, difficulty is encountered in separating the master carrier from the slave medium, degrading mass-production suitability.

As described above, conventional techniques are difficult to realize satisfactory magnetic transfer on a short-bit medium.

### BRIEF SUMMARY OF THE INVENTION

An object of the present invention is to provide a magnetic transfer method for a magnetic recording medium including application of a pulse magnetic field under predetermined conditions using a magnetic transfer master carrier having perpendicular magnetic anisotropy; and a perpendicular magnetic recording medium obtained by the magnetic transfer method, which medium exhibits an excellent signal quality; i.e., an increased reproduced signal output and small variation in width of a waveform.

Means for solving the problems pertinent in the art are as follows.

<1> A magnetic transfer method for a magnetic recording medium, in which method magnetic information is recorded on a perpendicular magnetic recording medium through magnetic transfer, the method including:

initially magnetizing a perpendicular magnetic recording medium by applying a DC magnetic field thereto in a perpendicular direction, and

applying, to the perpendicular magnetic recording medium, a DC magnetic field for 100 nsec to 1 see in an opposite direction to the magnetic field applied in initial magnetization with the recording medium being closely attached to a magnetic transfer master carrier which transfers magnetic information to the recording medium with being brought into contact with the recording medium,

wherein the master carrier comprises transfer portions on which surfaces a magnetic layer corresponding to magnetic information is laid, and non-transfer portions which are concave portions lower in height than the transfer portions, and

wherein the magnetic layer has perpendicular magnetic anisotropy and has a residual magnetization Mr of 500 emu/cc or lower and a saturation magnetization Ms of 900 emu/cc or higher.

<2> The magnetic transfer method according to <1> above, wherein the magnetic layer of the master carrier is made of CoPt.

<3> The magnetic transfer method according to <1> above, wherein the magnetic layer of the master carrier is made of Co₄Pt₁ (atomic ratio)

<4> The magnetic transfer method according to <1> above, wherein the master carrier further includes an underlying layer under the magnetic layer, and the underlying layer is made of CoCr, Ru, Pt, or a combination thereof.

<5> The magnetic transfer method according to <1> above, wherein the magnetic layer is laid only on the transfer portions, and the transfer portions with the magnetic layer laid on surfaces thereof are more protruded by the thickness of the magnetic layer than the non-transfer portions.

<6> The magnetic transfer method according to <1> above, wherein the perpendicular magnetic recording medium has a coercive force He of 4,000 Oe or higher.

<7> A magnetic recording medium obtained by a method comprising:

initially magnetizing a perpendicular magnetic recording medium by applying a DC magnetic field thereto in a perpendicular direction,

applying, to the perpendicular magnetic recording medium, a DC magnetic field for 100 nsec to 1 see in an opposite direction to the magnetic field applied in initial magnetization with the recording medium being closely attached to a magnetic transfer master carrier which transfers magnetic information to the recording medium with being brought into contact with the recording medium,

wherein the master carrier comprises transfer portions on which surfaces a magnetic layer corresponding to magnetic information is laid, and non-transfer portions which are concave portions lower in height than the transfer portions, and

wherein the magnetic layer has perpendicular magnetic anisotropy and has a residual magnetization Mr of 500 emu/cc or lower and a saturation magnetization Ms of 900 emu/cc or higher.

The present invention can provide a magnetic transfer method for a magnetic recording medium including application of a pulse magnetic field under predetermined conditions using a magnetic transfer master carrier having perpendicular magnetic anisotropy; and a perpendicular magnetic recording medium obtained by the magnetic transfer method, which medium exhibits an excellent signal quality; i.e., an increased reproduced signal output and small variation in width of a waveform. These can solve the existing problems.

### BRIEF DESCRIPTION OF THE DRAWINGS

FIG. 1 is a graph of a bit length vs. a difference in magnetization brought by a magnetic field between convex and concave portions.

FIG. 2 is a graph of a magnetic field applied vs. a magnetization.

FIG. 3 shows M-H characteristics of a magnetic film used in a slave disc.

FIG. 4 is a cross-sectional view of a conventional magnetic layer-embedded master carrier.

FIG. 5A schematically shows a step of a magnetic transfer method in an embodiment of the present invention.

FIG. 5B schematically shows a step of a magnetic transfer method in an embodiment of the present invention.

FIG. 5C schematically shows a step of a magnetic transfer method in an embodiment of the present invention.

FIG. 6 is a schematic cross-sectional view of a slave disc.

FIG. 7 is a schematic cross-sectional view of a magnetic layer (recording layer) after an initial magnetization step, wherein the magnetic layer is magnetized in a direction indicated by arrows.

FIG. 8A is a cross-sectional view of one exemplary master disc.

FIG. 8B is a cross-sectional view of another exemplary master disc.

FIG. 9 is a graph of a magnetic field applied vs. a magnetization.

FIG. 10 is a simulation graph of a saturation magnetization Ms vs. a difference in magnetic field between convex and concave portions.

FIG. 11 is a simulation graph of a magnetic field vs. a position in the boundary region between the convex and concave portions, wherein “A” corresponds to a curve with respect to a perpendicular magnetic anisotropic film and “B” corresponds to a curve with respect to an isotropic magnetic film.

FIG. 12 shows the position on a master which corresponds to the horizontal axis of FIG. 11.

FIG. 13A is an explanatory view used for showing a situation where a master disc slides against a slave disc in an in-plane direction during separation thereof.

FIG. 13B shows a situation where a master disc slides against a slave disc in an in-plane direction during separation thereof.

FIG. 14A is an explanatory view used for showing a situation where a master disc slides against a slave disc in an in-plane direction during separation thereof.

FIG. 14B shows a situation where a master disc slides against a slave disc in an in-plane direction during separation thereof

FIG. 15 is a graph of an M-H characteristics of a magnetic film used in a slave disc.

FIG. 16 is a graph of a magnetic field generated vs. a distance from a master disc.

FIG. 17 is a graph of an M-H characteristics of Co₄Pt₁ (atomic ratio) used in a master magnetic layer.

FIG. 18A shows a step of a manufacturing method for a master disc.

FIG. 18B shows a step of a manufacturing method for a master disc.

FIG. 18C shows a step of a manufacturing method for a master disc.

FIG. 18D shows a step of a manufacturing method for a master disc.

FIG. 18E shows a step of a manufacturing method for a master disc.

FIG. 18F shows a step of a manufacturing method for a master disc.

FIG. 18G shows a step of a manufacturing method for a master disc.

FIG. 18H shows a step of a manufacturing method for a master disc.

FIG. 18I shows a step of a manufacturing method for a master disc.

FIG. 18J shows a step of a manufacturing method for a master disc.

FIG. 19 is a top plan view of a master disc.

FIG. 20 is an explanatory view of a magnetic transfer step.

FIG. 21 schematically shows the configuration of a magnetic field applying apparatus used in a magnetic transfer step.

FIG. 22 is a schematic cross-sectional view of a magnetic layer having undergone a magnetic transfer step, wherein the direction in which the magnetic layer is magnetized is shown.

FIG. 23 is a graph of a hysteresis curve given by a magnetic recording medium.

FIG. 24 is an enlarged view of a concavo-convex pattern formed in the surface of a master disc.

FIG. 25 is a graph of an exemplary hysteresis curve given by a magnetic recording medium.

FIG. 26 is a graph of a magnetization quantity of a medium vs. a magnetic field application time (speed), wherein “A” corresponds to a curve given when the application speed is optimum, “B” corresponds to a curve given when the application speed is high, and “C” corresponds to a curve given when the application speed is low.

FIG. 27A is a graph of the waveform of a transfer signal.

FIG. 27B is a graph of the waveform of a transfer signal.

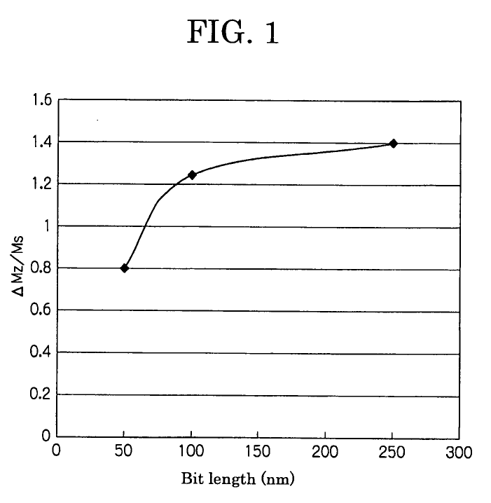

### DETAILED DESCRIPTION OF THE INVENTION

### (Magnetic Transfer Method for Magnetic Recording Medium)

A magnetic transfer method of the present invention for recording magnetic information on a perpendicular magnetic recording medium through magnetic transfer, the method includes initially magnetizing a perpendicular magnetic recording medium by applying a DC magnetic field thereto in a perpendicular direction, and applying, to the perpendicular magnetic recording medium, a DC magnetic field for 100 nsec to 1 see in an opposite direction to the magnetic field applied in initial magnetization with the recording medium being closely attached to a magnetic transfer master carrier which transfers magnetic information to the recording medium with being brought into contact with the recording medium, wherein the master carrier comprises transfer portions on which surfaces a magnetic layer corresponding to magnetic information is laid, and non-transfer portions which are concave portions lower in height than the transfer portions, and wherein the magnetic layer has perpendicular magnetic anisotropy and has a residual magnetization Mr of 500 emu/cc or lower and a saturation magnetization Ms of 900 emu/cc or higher.

A DC magnetic field which acts in an opposite direction to the magnetic field perpendicularly applied for initial magnetization is applied to the perpendicular magnetic recording medium and the magnetic transfer master carrier that have been closely attached to each other for 100 nsec to 1 sec, preferably 1 μsec to 100 msec, more preferably 100 μsec to 10 msec.

When the application time is shorter than 100 nsec, both Hc (coercive force) and Hn (reverse magnetic domain nucleus forming magnetic field) increase. As a result, the convex portion of the master disc is not completely magnetized, potentially degrading the quality of a transfer signal. When the application time is longer than 1 sec, both Hc (coercive force) and Hn (reverse magnetic domain nucleus forming magnetic field) decrease. As a result, a magnetic field in the concave portion of the master disc is greater than Hn, potentially degrading the quality of a transfer signal.

Referring now to the drawings attached, next will be described in detail preferred embodiments of the present invention.

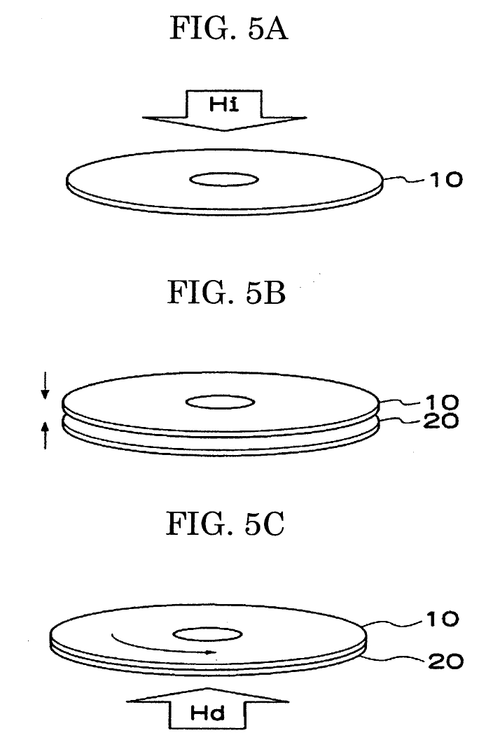

Firstly, with reference to FIGS. 5A to 5C, a magnetic transfer technique with respect to perpendicular magnetic recording will be roughly described below. FIGS. 5A to 5C are schematic sketches of steps of a magnetic transfer method for perpendicular magnetic recording. In these figures, reference numeral 10 denotes a slave disc (magnetic disc for transfer) serving as a magnetic disc to which information is to be transferred (the slave disc corresponding to a “perpendicular magnetic recording medium”and reference numeral 20 denotes a master disc serving as a master carrier.

Specifically, a DC magnetic field (Hi) is applied to a slave disc 10 in a perpendicular direction for initial magnetization as shown in FIG. 5A (initial magnetization step). Thereafter, the slave disc 10 is closely attached to a master disc 20 as shown in FIG. 5B (closely attaching step). Subsequently, while the discs are being closely attached to each other, as shown in FIG. 5C, a magnetic field (Hd) is applied for magnetic transfer in an opposite direction to the DC magnetic field (Hi) used for initial magnetization (transfer step).

### [Description of Magnetic Disc for Transfer (Slave Disc)]

The slave disc 10 used in this description include a disc-shaped substrate and a magnetic layer made of a perpendicularly magnetized film, wherein at least one surfaces of the substrate is provided with the magnetic layer. Specific examples thereof include high-density hard discs.

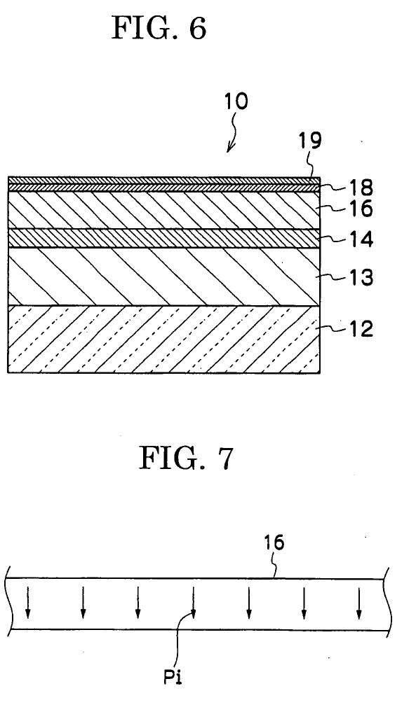

FIG. 6 is a schematic cross-sectional view of the slave disc 10. As shown in FIG. 6, the slave disc 10 includes, in sequence, a non-magnetic substrate 12 made of, for example, glass, a soft magnetic layer (soft magnetic underlying layer (SUL)) 13, a non-magnetic layer (intermediate layer) 14, a magnetic layer (perpendicular magnetic recording layer) 16, a protective layer 18 and a lubricating layer 19. Here, the slave disc 10 has the magnetic layer 16 over one surface of the substrate 12. Also, a magnetic layer may be formed over both surfaces of the substrate 12.

The disc-shaped substrate 12 is made of a non-magnetic material such as glass and aluminum (Al). The soft magnetic layer 13 is formed on the substrate 12, and then the non-magnetic layer 14 and the magnetic layer 16 are formed thereon.

The soft magnetic layer 13 effectively stabilizes perpendicular magnetization in the magnetic layer 16 and enhances sensitivity during recording/reproducing. The soft magnetic layer 13 is preferably made of a soft magnetic material such as CoZrN , FeTaC, FeZrN, FeSi alloy, FeAl alloy, FeNi alloy (e.g., permalloy) and FeCo alloy (e.g., permendur). The soft magnetic layer 13 is treated so as to have magnetic anisotropy oriented in a radial direction of a disc (in a radial fashion) (i.e., from the center to the periphery).

The soft magnetic layer 13 preferably has a thickness of 50 nm to 2,000 nm, more preferably 80 nm to 400 nm.

The non-magnetic layer 14 is provided for the purposes of, for example, increasing the perpendicular magnetic anisotropy of the magnetic layer 16 to be formed thereon. The non-magnetic layer 14 is preferably made of, for example, titanium (Ti), chromium (Cr), CrTi, CoCr, CrTa, CrMo, NiAl, ruthenium (Ru), palladium (Pd), Ta or Pt. The non-magnetic layer 14 is formed through sputtering of the above material. The thickness of the non-magnetic layer 14 is preferably 10 nm to 150 nm, more preferably 20 nm to 80 nm.

The magnetic layer 16 is made of a perpendicularly magnetized film (a magnetic film in which most of axes of easy magnetization are arranged perpendicularly to a substrate), and information is recorded on the magnetic layer 16. The magnetic layer 16 is preferably made of, for example, cobalt (Co), Co alloy (e.g., CoPtCr, CoCr, CoPtCrTa, CoPtCrNbTa, CoCrB and CoNi), Co alloy-SiO₂, Co alloy-TiO₂, Fe or Fe alloy (e.g., FeCo, FePt and FeCoNi).

These materials have a high magnetic flux density, and can be treated so as to have perpendicular magnetic anisotropy by controlling film-forming conditions or its composition. The magnetic layer 16 is formed through sputtering of the above material. The magnetic layer 16 preferably has a thickness of 10 nm to 500 nm, more preferably 20 nm to 200 nm.

In this embodiment, a disc-shaped glass substrate having an outer diameter of 65 mm is used as the substrate 12 of the slave disc 10. This glass substrate is placed in the chamber of a sputtering apparatus. The chamber is reduced in pressure to 1.33×10⁻⁵ Pa (1.0×10⁻⁷ Torr), and then argon (Ar) gas is introduced to the chamber. The temperature of the substrate in the chamber is adjusted to room temperature, and the first layer (thickness: 80 nm) of the SUL is formed through sputtering on the substrate using a CoZrNb target in the chamber. Then, an Ru layer (thickness: 0.8 nm) is formed on the thus-formed first layer through sputtering using an Ru target in the chamber. Then, the second layer (thickness: 80 nm) of the SUL is formed through sputtering using a CoZrNb target. The SUL formed through sputtering is increased to room temperature while a magnetic field of 50 Oe or higher is applied thereto in a radial direction, and maintained at room temperature.

Next, sputtering is carried out using a CrTi target through discharging with the substrate being adjusted to room temperature, to thereby form a non-magnetic layer 14 made of CrTi (thickness: 60 nm).

Thereafter, similar to the above, Ar gas is introduced to the chamber and then, sputtering is carried out using a CoCrPt target in the same chamber through discharging with the substrate being adjusted to room temperature, to thereby form a granular magnetic layer 16 made of CoCrPt—SiO₂ (thickness: 25 nm).

Through the above procedure, a magnetic disc for transfer (slave disc) 10 was formed, which includes, in sequence, a glass substrate, a soft magnetic layer, a non-magnetic layer and a magnetic layer.

The slave disc preferably has a coercive force He of 4,000 Oe or higher, more preferably 5,000 Oe or higher. When the coercive force Hc is lower than 4,000 Oe, unnegligible heat fluctuation may be caused to prevent high-density (short-bit) recording.

### [Initial Magnetization of Slave Disc]

Next, the slave disc 10 formed is subjected to initial magnetization. The initial magnetization (DC magnetization) of the slave disc 10 is carried out through application of an initializing magnetic field Hi generated from a device (unillustrated magnetic field applying unit) which is capable of applying a DC magnetic field to a surface of the slave disc 10 in a perpendicular direction (as described above with reference to FIG. 5A). Specifically, the initializing magnetic field Hi is a magnetic field having an intensity equal to or higher than the coercive force Hc of the slave disc 10. In the slave disc 10 having undergone this initial magnetization step, as shown in FIG. 7, the magnetic layer 16 has a unidirectional initial magnetization Pi which is perpendicular to the disc surface. Notably, the initial magnetization may be carried out by rotating the slave disc 10 with respect to the magnetic field applying unit.

### [Embodiment of Master Disc]

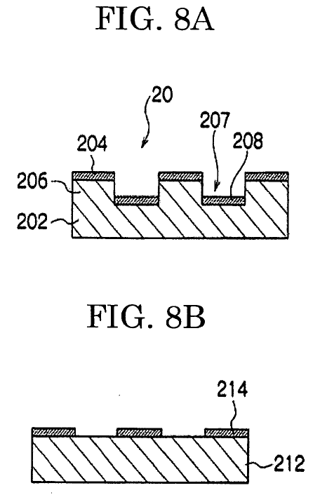

Next will be described the master disc 20 serving as a master carrier. FIGS. 8A and 8B exemplarily show embodiments of the master disc 20. Preferably, the master disc 20 has, as shown in FIG. 8A, magnetic layers 204 on a concavo-convex surface of a base material 202; or has, as shown in FIG. 8B, magnetic layers 214 and a flat base material 212, wherein the layers are formed on the substrate surface only at bit portions corresponding to transfer signals (each bit portion corresponding to a “transfer portion” where initial magnetization is to be inverted).

In the embodiment shown in FIG. 8A, the magnetic layers 204 formed on convex portions 206 of the base material 202 serve as bit portions corresponding to transfer signals (portions where initial magnetization is to be inverted). As shown in FIG. 8A, magnetic layers 208 are formed on concave portions 207 of the base material 202 (each concave portion corresponding to a “non-transfer portion”, but the magnetic layers 208 are not necessarily formed on the concave portions 207. Also, manufacture of the master disc in which the magnetic layers 204 and 208 are formed on the convex portions 206 and the concave portions 207, respectively (as shown in FIG. 8A) is easier than that of the master disc in which the magnetic layers 204 are formed only on the convex portions 206.

As used herein, the sentence/term “bit is shot” or “short bit” means that, in FIG. 8A, the width of the magnetic layer 204 formed on each convex portion 206 is narrow; or, in FIG. 8B, the width of each magnetic layer 214 is narrow.

In any embodiments shown in FIGS. 8A and 8B, the magnetic layer 204 or 214 serving as the bit portion (corresponding to transfer signals) is the highest in height in each master disc 20 (the protective layer, the lubricating layer, etc. being excluded). In other words, other portions than the bit portions (non-bit portions) are lower in height than the magnetic layer 204 or 214 (bit portion). That is, the master disc 20 has the magnetic layer 204 or 214 (bit portion) as the uppermost layer (provided that the magnetic layer 204 or 214 is provided thereon with the protective layer and/or the lubricating layer in some cases) and the non-bit portions lower in height than the bit portion. As a result, the master disc has a concavo-convex surface.

The following description is mainly about the embodiment shown in FIG. 8A, but is also applicable to the embodiment shown in FIG. 8B.

### [Magnetic Layer of Master Disc]

Table 1 shows preferred magnetic characteristics of the magnetic layer 204 of the master disc 20. For comparison, Table 1 also shows magnetic characteristics of a perpendicular magnetic recording film serving as a recording layer of the slave disc 10.

TABLE 1

| | Perpendicularly | Perpendicularly | |
|---|---|---|---|
| | magnetized film for | magnetized film for | |
| | master disc | magnetic recording | Effects |
| Residual magnetization | Absolutely low | Absolutely high | High value results in severe |
| Mr | (≦500 emu/cc) | | noise |
| Squareness ratio SQ | Small (≦0.6) | 1 | |
| Saturation | Absolutely high | Low value allowable | Low value results in |
| magnetization Ms | (≧900 emu/cc) | (about 400 emu/cc) | insufficient transfer |
| | | | magnetic field |
| Hs (magnetic field | Absolutely low | High value allowable | High value results in |
| required for Ms) | | | insufficient resolution |
| Reverse magnetic | Small in the first | In the second quadrant | In the second quadrant, high |
| domain nucleus | quadrant | | Mr results in severe noise |
| forming magnetic field | | | |
| Hn | | | |
| Anisotropy constant Ku | Small value allowable | Absolutely large | |
| | | ≧5 × 10⁶ (erg/cc) | |
| | | preferably | |
| Coercive force Hc | ≦Medium value | Absolutely large | Large value results in |
| | | ≧4,000 Oe preferably | insufficient resolution |
| Magnetic permeability μ | ≧100 preferably | Low value allowable | |

Next will be described the reasons why a magnetic layer having magnetic characteristics shown in Table 1 is suitably used as the magnetic layer of the master carrier

[Comparison of Perpendicular Magnetic Anisotropic Film with Magnetic Isotropic Film]

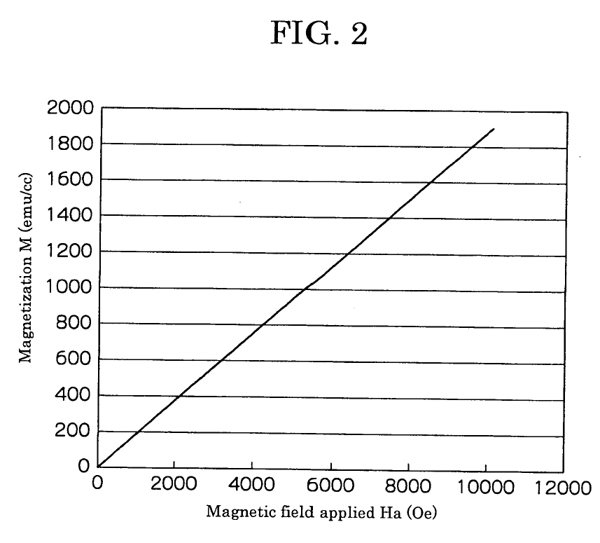

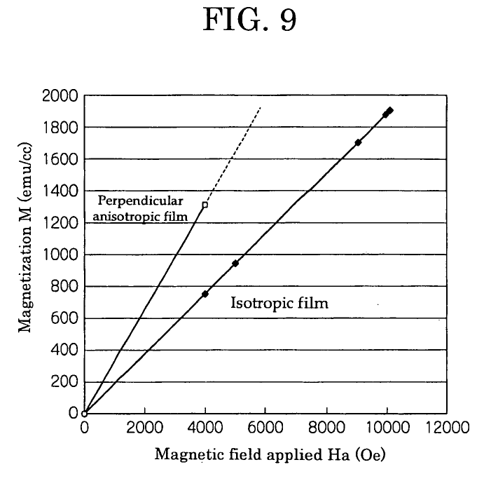

FIG. 9 shows a relationship between the intensity of a magnetic field applied and the intensity of magnetization of a master magnetic layer. Here, a perpendicular magnetic anisotropic film used was a magnetic film having a saturation magnetization Ms of 1,300 emu/cc and requiring a magnetic field of 4,000 Oe for reaching saturation magnetization. The magnetic film was compared with a magnetic isotropic film in terms of change in magnetization in accordance with increase in intensity of the magnetic field applied. The shape of the magnetic film was the same as described with reference to FIG. 2.

As shown in FIG. 9, when a magnetic field of 4,000 Oe is applied, the magnetization of the magnetic isotropic film is less than 800 emu/cc and the magnetization of the perpendicular magnetic anisotropic film reaches 1,300 emu/cc (saturation magnetization). By virtue of its perpendicular magnetic anisotropy, the perpendicular magnetic anisotropic film is effectively magnetized by the magnetic field applied. Notably, a perpendicular magnetic anisotropic film having a saturation magnetization Ms higher than 1,300 emu/cc is further magnetized so as to indicate a magnetization corresponding to a dotted line in FIG. 9.

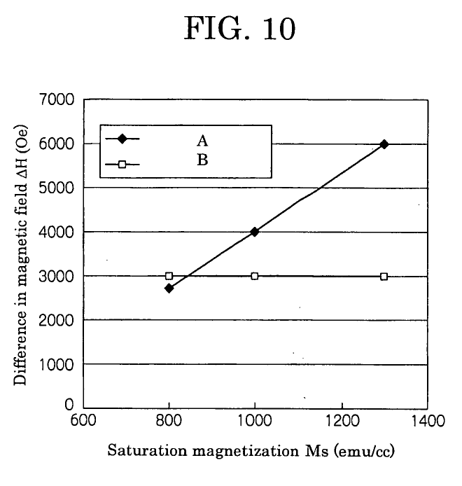

FIG. 10 is a simulation graph of a saturation magnetization Ms vs. a difference in magnetic field between convex and concave portions. The graph of FIG. 10 is obtained as follows. Specifically, a perpendicular magnetic anisotropic film having a thickness of 100 nm is formed on a master having concavo-convex portions (i.e., a master carrier shown in FIG. 8A), the master having a bit width of 100 nm and a radial length of 100 nm; and the intensity of the magnetic field generated during transfer is measured/calculated at a position which is 10 nm apart from the master. For comparison, the graph shows values of both the perpendicular magnetic anisotropic film (indicated by “A” in FIG. 10) and the magnetic isotropic film (indicated by “B” in FIG. 10).

In the graph of FIG. 10, the horizontal axis corresponds to a saturation magnetization Ms, and the vertical axis corresponds to the difference in magnetic field (ΔH) generated during transfer between convex and concave portions. For realizing preferred transfer, preferably, the magnetic field of the convex portions is greater; and the magnetic field of the concave portions is smaller so as to avoid inversion of the initial magnetization of the slave medium at corresponding portions.

As shown in FIG. 10, in the case of the magnetic anisotropic film, the difference in magnetic field (ΔH) cannot exceed a certain value even when the saturation magnetization is increased, since the magnetic field leaks in the concave portions. In contrast, in the case of the perpendicular magnetic anisotropic film, the difference in magnetic field (ΔH) can be increased in accordance with increase in saturation magnetization by virtue of its perpendicular magnetic anisotropy. As is clear from FIG. 10, the perpendicular magnetic anisotropic film is very advantageously used at a saturation magnetization higher than 800 emu/cc. Desirably, it is used at a saturation magnetization Ms of 900 emu/cc or higher.

Such effect that is given by perpendicular magnetic anisotropy reduces a magnetic field at the concave portions, and the boundary region has a sharp magnetic field distribution (i.e., drastic change in magnetic field is observed between the convex and concave portions).

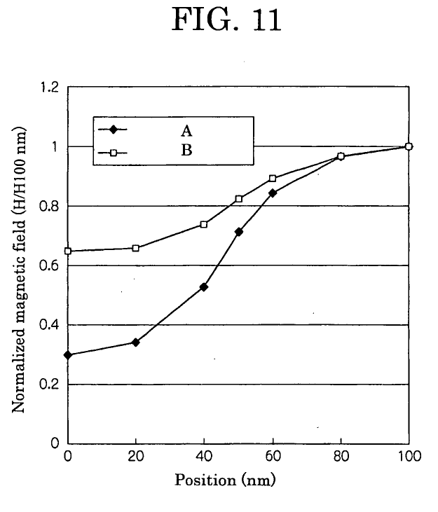

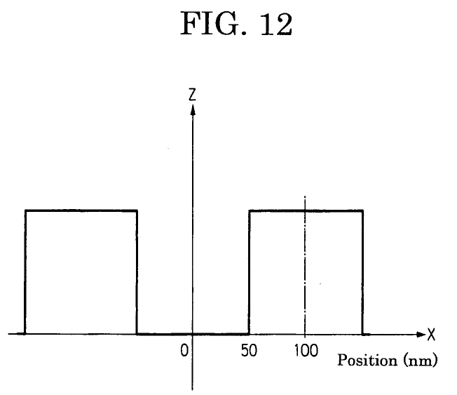

FIG. 11 is a simulation graph of a magnetic field vs. a position in the boundary region between the convex and concave portions, which is obtained by applying a transfer magnetic field of 4,000 Oe to a magnetic layer having a bit length of 100 nm. In FIG. 11, the horizontal axis corresponds to a position in an in-plane direction (radial or circumferential direction) of a master disc. As shown in FIG. 12, the origin of the position (x=0) is the center of the concave portion. The position specified by “x=50 nm” is the boundary between the concave portion and the convex portion. The position specified by “x=100 nm” is the center of the convex portion.

The horizontal axis of the graph of FIG. 11 corresponds to a normalized magnetic field which is obtained by dividing an actual value by a magnetic field at the center of the convex portion (x=100 nm). As shown in FIG. 11, a perpendicular magnetic anisotropy film-bit portion exhibits more drastic change in magnetic field at the boundary region than a magnetic isotropic film-bit portion. Specifically, at around x=50 nm, a curve of the perpendicular magnetic anisotropy film (bit portion) has a gradient about twice greater than a curve of the magnetic isotropic film (bit portion). In other words, a perpendicular magnetic anisotropy film realizes a drastic change in magnetic field about twice greater than a magnetic isotropic film. When such a perpendicular magnetic anisotropy film is used, a magnetic field having such a sharp magnetic field distribution can be applied to the slave disc 10 during transfer, resulting in attaining sharp signal recording on the slave disc 10.

### [Regarding Residual Magnetization Mr]

The residual magnetization Mr of a master magnetic layer is preferably smaller. When the residual magnetization Mr is equal to or greater than a certain value, a master disc undesirably generates a magnetic field even after completion of application of a transfer magnetic field. As a result, unnecessary transfer is caused when the master disc 20 is separated from the slave disc 10, leading to occurrence of signal noise.

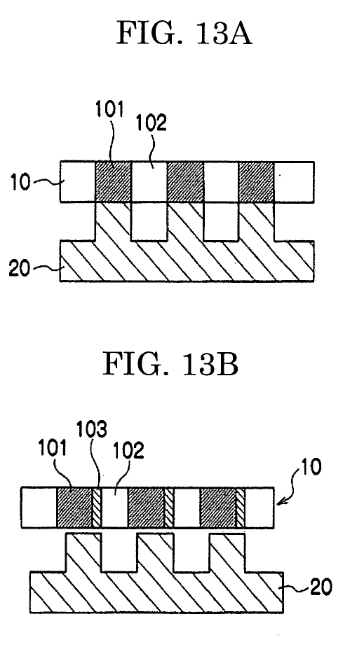

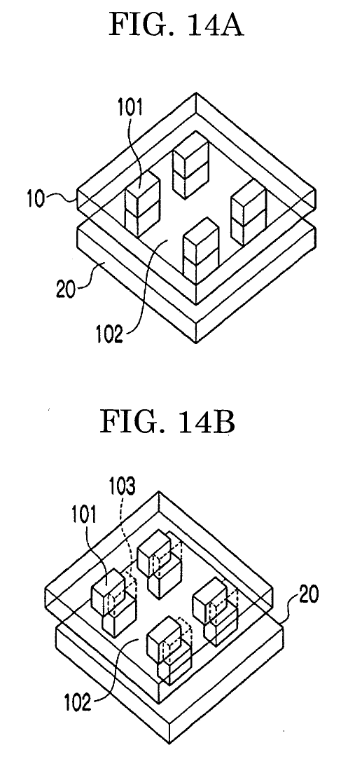

FIGS. 13A, 13B, 14A and 14B schematically show the situation described above. FIG. 13A or 14A is a sketch showing a state where the discs are closely attached to each other during transfer. As shown in this sketch, in the slave disc 10, the magnetization of portions (indicated by reference numeral 101) which are attached to convex portions of the master disc is in an opposite direction to the initial magnetization of portions (indicated by reference numeral 102) which correspond to concave portions.

After the transfer step as shown in FIG. 13A or 14A (i.e., after completion of application of transfer magnetic field), the master disc 20 is separated from the slave disc 10. During this separation, the discs may slide against each other in an in-plane direction as shown in FIGS. 13B and 14B.

In the slave disc, the portions indicated by reference numeral 102, which are other than the portions attached to the convex portions, must be maintained so as to have an initial magnetization. The master magnetic layer having a high residual magnetization Mr undesirably generates a magnetic field even after completion of application of a transfer magnetic field. Thus, when the discs slide against each other in an in-plane direction during separation thereof, part (indicated by reference numeral 103) of each portion (indicated by reference numeral 102) which corresponds to the concave portion is adversely affected by a residual magnetic field, resulting in degradation of initial magnetization thereof.

In order to avoid such a problem, the residual magnetization Mr of the master magnetic layer is adjusted to 500 emu/cc or lower. The reason for this will next be described.

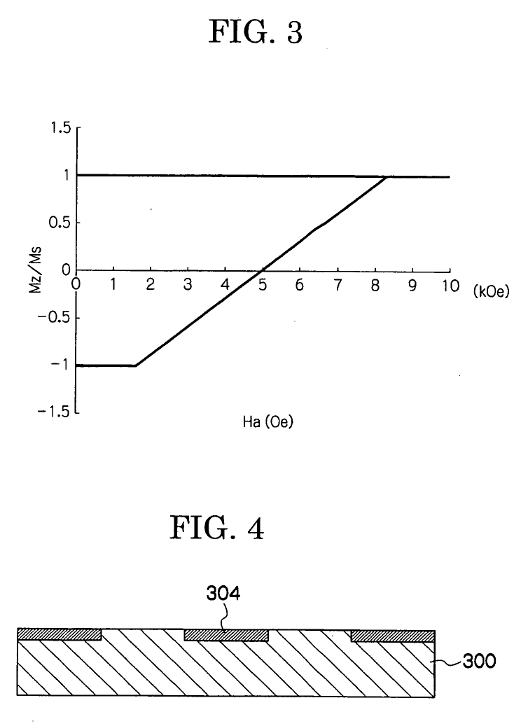

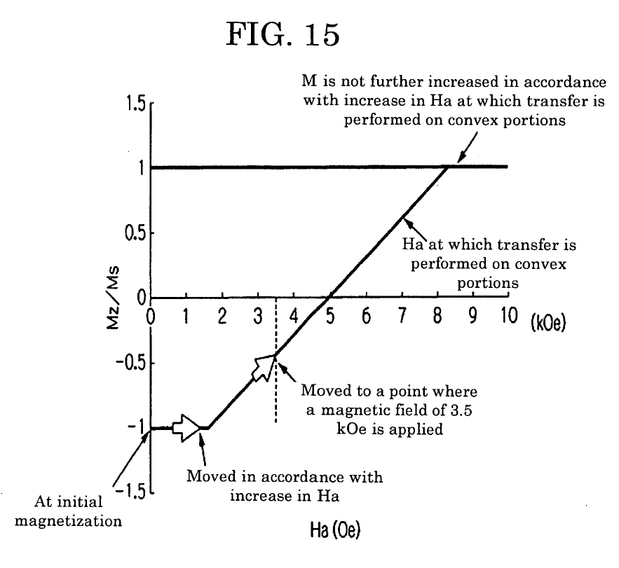

FIG. 15 is an M-H curve of a typical magnetic layer used in the slave disc 10 (similar to FIG. 3). In FIG. 15, the horizontal axis corresponds to a magnetic field applied, and the vertical axis corresponds to a magnetization normalized by the saturation magnetization Ms.

From the graph of FIG. 15, the magnetic layer is magnetized at the initial magnetization step so as to have a normalized magnetization of −1. In this state, a magnetic field on surfaces of convex portions of the master disc increases under application of a transfer magnetic field Ha. The normalized magnetization is changed as indicated by thick arrows in FIG. 15 depending on an increase in transfer magnetic field. As described above with reference to FIG. 3, ΔMr/Ms is ideally 2. But, when the bit length is 50 nm, ΔMr/Ms is about 0.8.

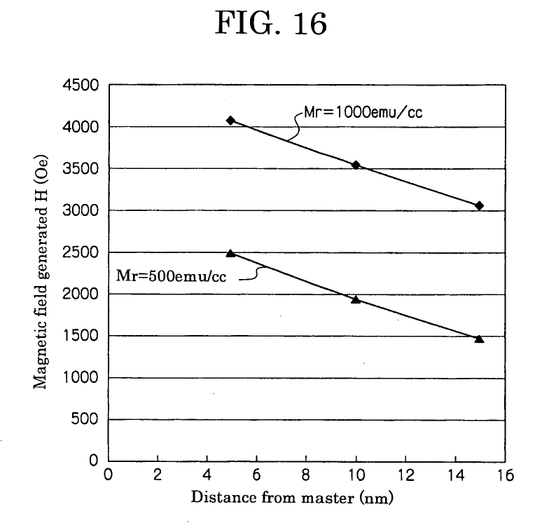

FIG. 16 is a graph of a magnetic field generated by the master disc 20 having a magnetic layer with perpendicular magnetic anisotropy vs. a distance from the master disc. This graph is obtained by adjusting the magnetic field to 0 after transfer and thus, the magnetic field is formed by the residual magnetization of the magnetic layer. The graph of FIG. 16 shows the case where the magnetic layer is made of a perpendicular magnetic anisotropic film having a residual magnetization Mr of 1,000 emu/cc and the case where the magnetic layer is made of a perpendicular magnetic anisotropic film having a residual magnetization Mr of 500 emu/cc.

In FIG. 16, the horizontal axis corresponds to a distance from the surface of the master disc, and the vertical axis corresponds to a magnetic field generated. FIG. 16 indicates the intensity of a magnetic field each magnetic layer has after completion of application of the magnetic field for transfer. As the distance from the master surface is greater, the magnetic field tends to be reduced. At a point 10 nm distant from the master surface, the master disc having the perpendicular magnetic anisotropic film with a residual magnetization Mr of 11,000 emu/cc (SQ=1) generates a magnetic field of about 3.5 kOe, and the master disc having the perpendicular magnetic anisotropic film with a residual magnetization Mr of 500 emu/cc (SQ=0.5) generates a magnetic field of about 2 kOe.

Next, there will be examined the effects of such a residual magnetic field to a slave disc having undergone transfer. In a slave disc having a magnetic layer exhibiting an M-H curve shown in FIG. 15, if the magnetization of the magnetic layer of the slave disc is completely recorded (by utilizing performance of the magnetic layer to the greatest extent) at the initial magnetization step and the transfer step, a portion of the slave disc which corresponds to a concave portion of the master disc (i.e., which is not attached to a bit portion of the master magnetic layer) (hereinafter the portion of the slave disc is referred to as a “non-transfer portion”) is maintained to have initial magnetization as shown in FIG. 15, and ΔMr/Ms of the non-transfer portion is −1.

After a magnetic transfer step, if the master disc 20, which has a perpendicular magnetic anisotropic film with a residual magnetization Mr of 1,000 emu/cc (SQ=1), and the slave disc 10 slide against each other by several tens nanometers in an in-plane direction during separation thereof at a transfer magnetic field of 0, a magnetic field of about 3.5 kOe generated from a convex portion changes the initial magnetization of the slave disc from −1 to −0.5 as shown in the M-H curve of FIG. 15; i.e., the initial magnetization thereof is degraded by 50%. Notably, when the performance of the slave magnetic layer is not be utilized for recording to the greatest extent and the initial magnetization is originally inferior to −1, the initial magnetization is more severely degraded.

Also, when a master disc having a perpendicular magnetic anisotropic film with a residual magnetization Mr of 500 emu/cc (SQ=0.5) is used, a magnetic field generated from the convex portion is lower than 2 kOe (FIG. 16). From the M-H curve of FIG. 15, the magnetization of the magnetic film in the state of initial magnetization increases when an external magnetic field Ha slightly higher than 2 kOe is applied thereto. Thus, an external magnetic field lower than 2 kOe merely changes the magnetization of the magnetic film to a negligible extent.

Thus, in the case where a perpendicular magnetic anisotropic film having a residual magnetization Mr of 500 emu/cc (SQ=0.5) is used, even when the master and slave discs slide against each other in an in-plane direction, almost no effects are given by a magnetic field generated (lower than 2 kOe). As shown in the M-H curve of FIG. 15, in the slave disc, the intensity of the initial magnetization is almost the same as that of the magnetization after transfer, causing almost no degradation of the magnetization.

Notably, when a perpendicular magnetic anisotropic film used has a residual magnetization Mr lower than 500 emu/cc, as shown in FIG. 16, the intensity of a magnetic field generated therefrom is lower than that of a magnetic field generated from the perpendicular magnetic anisotropic film having a residual magnetization Mr of 500 emu/cc. Thus, similar to the perpendicular magnetic anisotropic film having an Mr of 500 emu/cc, almost no effects are given by a residual magnetic field.

In actual manufacturing steps, when the master disc 20 is separated from the slave disc 10 after the magnetic transfer step, the discs unavoidably slide against each other by about 100 nm in a radial direction. Thus, it is important that a master magnetic layer used has a residual magnetization Mr of 500 emu/cc or lower.

The reason why effects of a residual magnetic field are examined at a point 10 nm distant from the master surface is reasonable as follows. Specifically, in the layer structure of the slave disc 10 (see FIG. 6), the magnetic layer 16 is provided thereon with the protective layer 18 and the lubricating layer 19. Presumably, for example, the protective layer 18 made of a carbon film has a thickness of about 3 nm, and the lubricating layer 19 has a thickness of 1 nm to 2 nm. Meanwhile, a protective layer (e.g., a carbon film) having a thickness of about 5 nm is often formed on the magnetic layer of the master disc 20.

That is, in the state where the master disc 20 is closely attached to the slave disc 10 during transfer, the magnetic layer of the master disc 20 is about 10 nm distant from the magnetic layer 16 of the slave disc 10, since non-magnetic films (e.g., a protective layer) is provided between the magnetic layers. Actually, the interdistance between the magnetic layers may be greater than 10 nm. But, the greater the interdistance between the magnetic layers, the weaker a magnetic field generated. Thus, effects of a residual magnetic field are examined at a point 10 nm distant from the master surface.

### [Regarding Anisotropy Constant Ku]

Regarding anisotropy constant Ku (erg/cm³), presumably, perpendicular magnetic recording media are required to have a value KuV/(kT) of 60 or more for maintaining information recorded by magnetization. In this value, V denotes a magnetization inversion volume (cm³), k denotes a Boltzmann constant (1.38×10⁻¹⁶ erg/deg) and T denotes a temperature.

The magnetization inversion volume V becomes smaller in accordance with an increase in recording density. Thus, for producing perpendicular magnetic recording media, a material used must have a high anisotropy constant Ku.

In contrast, regarding the master magnetic layer, information recording is carried out based on a magnetic pattern formed in a magnetic layer. Preferably, the magnetic pattern is formed only during transfer (only during application of a magnetic field for recording), and the magnetic pattern disappears after transfer (during completion of application of the magnetic field).

Thus, the anisotropy constant Ku of the master magnetic layer may be small In this point, a magnetic material for a perpendicular magnetic recording medium is greatly different from that for a master carrier

### [Regarding Reverse Magnetic Domain Nucleus Forming Magnetic Field Hn]

The reverse magnetic domain nucleus forming magnetic field Hn of the master magnetic layer is preferably equal to or lower than a magnetic field applied, since the saturation magnetization Ms of the master magnetic layer is effectively utilized. In general, the magnetic field applied does not exceed the coercive force Hc of a magnetic layer of the slave disc 10. Thus, the Hn of the master magnetic layer is adjusted to be equal to or lower than the He of the slave magnetic layer (i.e, Hn of master magnetic layer≦He of slave magnetic layer).

### [Regarding Coercive Force Hc]

When the coercive force He of the master magnetic layer is too high, the master magnetic layer is not magnetized by a magnetic field applied

Also, magnetic transfer cannot be carried out. Application of a high transfer magnetic field disadvantageously generates a magnetic field at concave portions. Thus, the coercive force He of the master magnetic layer is preferably 2,000 Oe or lower, more preferably 500 Oe or lower.

As described above, the master disc 20 having a perpendicularly magnetized film exhibiting magnetic characteristics shown in Table 1 attains transfer at an excellent S/N ratio for the following four reasons: (1) a transfer magnetic field increases at convex portions (transfer portions) which are attached to the slave disc 10, (2) a magnetic field is reduced at concave portions (non-transfer portions) by virtue of no demagnetic field, (3) the boundary region between the convex and concave portions has a sharp magnetic field distribution, and (4) undesirable transfer is not caused by the residual magnetization of the master disc 20 having undergone transfer.

### [Regarding Materials]

For example, the material for the master magnetic layer exhibiting magnetic characteristics shown in Table 1 is preferably CoPt, more preferably Co₄Pt₁ (atomic ratio). Table 1 shows the magnetic characteristics of the master magnetic layer made of Co₄Pt₁.

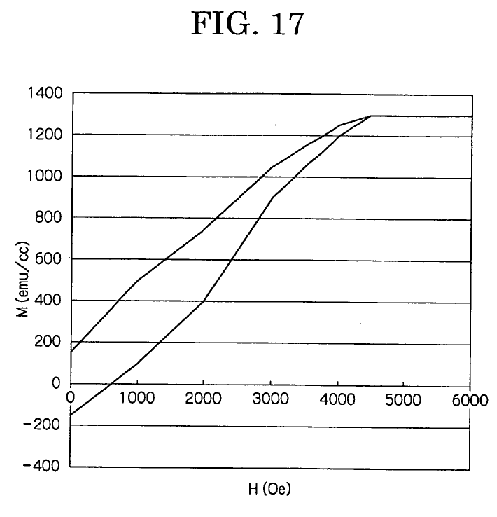

FIG. 17 is a graph (first quadrant) of an M-H curve of Co₄Pt₁ (atomic ratio). This material has a saturation magnetization Ms of 1,300 emu/cc, a residual magnetization Mr of 170 emu/cc, and a coercive force Hc of 600 Oe.

Needless to say, the material which can be used in the present invention is not limited thereto. Any other materials can be used, so long as they exhibit required characteristic values as described above.

Also, an underlying layer may be formed under a magnetic layer of the master disc 20. For example, the material for the underlying layer is preferably Pt, Ru and CoCr, more preferably CoCr whose Cr content is 25 atom % or higher, Pt and Ru. These materials may be used alone or combination.

The thickness of the underlying layer is preferably 0.5 nm to 30 nm, more preferably 1 nm to 10 nm.

### [Regarding Surface of Master Disc]

As described above with reference to FIG. 2, a so-called magnetic layer-embedded master disc has a flat surface to be attached to a slave disc and thus, the master disc cannot be closely attached to the slave disc. As described above with reference to FIGS. 8A and 8B, the master disc 20 preferably has magnetic layers 204 and 214 serving as transfer portions (which correspond to portions of the slave disc where the magnetization is inverted during transfer) and non-transfer portions lower than the top surface of each magnetic layer (i.e., each non-transfer portion has a concave shape).

In such a concavo-convex master carrier, when a conventional magnetic isotropic film is used as a magnetic layer, the bit portion must have a high aspect ratio (i.e., a ratio of the size in a depth direction to the size in a down-track direction). This is because a magnetic field must be effectively applied to the convex portion during transfer in consideration of the effects of a demagnetic field generated.

However, manufacturing of a concavo-convex master carrier having a high aspect ratio involves problems. For example, when a master disc is separated from an original master or is replicated, the convex portion of the master disc is chipped to become a reject product. When the aspect ratio exceeds 1, the reject product is increasingly yielded.

In contrast, a magnetic film having perpendicular magnetic anisotropy used in the present invention does not involve a demagnetic field and thus, the aspect ratio can be low and production yield is remarkably improved.

Also, the master disc 20 in the present invention is attached to a slave disc in a smaller surface area, as compared with a magnetic layer-embedded master disc (FIG. 4). Thus, after transfer, separation of the master disc from the slave disc can be easily performed for a short time, which improves productivity.

In order to further obtain the above-described advantageous effects, preferably, only portions corresponding to transfer signals have a convex shape; i.e., the other portions have a concave shape. In the case of transfer of servo signals, a data region has a concave shape. When a master disc having too large concave portions is superposed on a slave disc, the concave portions may be deformed and attached to a portion of the slave disc. In this case, small convex portions may be formed in the large concave portions to prevent such unfavorable phenomenon.

### [Manufacturing Method for Master Disc 20]

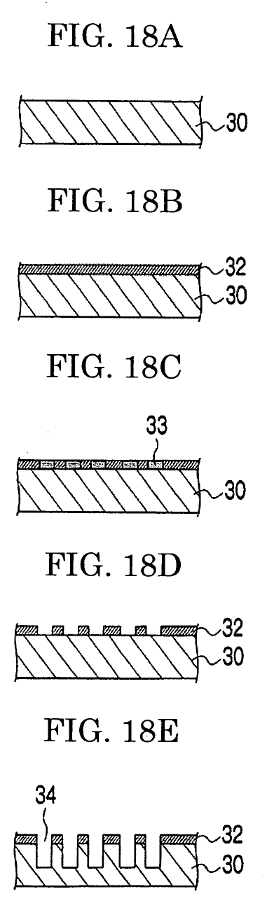

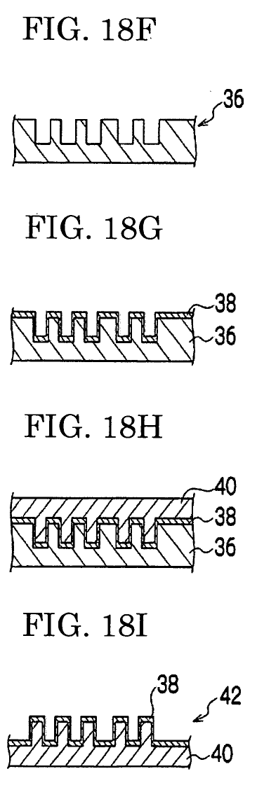

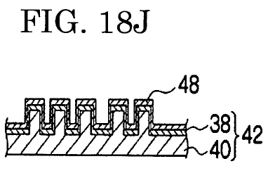

With reference to FIGS. 18A to 18J, next will be described a manufacturing method for the master disc 20. First, as shown in FIG. 18A, an original plate (Si substrate) 30—a silicon wafer having a smooth surface—is prepared, and then an electron beam resist solution is applied onto the original plate 30 by, for example, spin coating so as to form a resist layer 32 thereon (see FIG. 18B), followed by baking (pre-baking).

Next, the original plate 30 is set on a high-precision rotary stage or X-Y stage provided in an electron beam exposure apparatus (not shown), an electron beam modulated correspondingly to a servo signal is applied while the original plate 30 is being rotated, and a predetermined pattern 33 is formed on the substantially entire surface of the resist layer 32; for example, a pattern that corresponds to a servo signal and that linearly extends in the radial direction from the rotational center to each track is formed at portions corresponding to frames on the circumference by writing exposure (electron beam writing) (see FIG. 18C).

Subsequently, as shown in FIG. 18D, the resist layer 32 is developed, the exposed (written) portions are removed, and a coated layer having a desired thickness is formed as the remaining resist layer 32. This coated layer serves as a mask in the next step (etching step). Additionally, the resist applied onto the original plate 30 can be of positive type or negative type; it should be noted that an exposed (written) pattern formed when a positive-type resist is used is an inversion of an exposed (written) pattern formed when a negative-type resist is used. After this developing process, a baking process (post-baking) is carried out to enhance the adhesion between the resist layer 32 and the original plate 30.

Subsequently, as shown in FIG. 18E, part of the original plate 30 is removed (etched) from an opening portion 34 of the resist layer 32, such that hollows having a predetermined depth are formed in the original plate 30. As to this etching, anisotropic etching is preferable in that an undercut (side etching) can be minimized. As such anisotropic etching, reactive ion etching (RIE) can be suitably employed.

Thereafter, as shown in FIG. 18F, the resist layer 32 is removed. Regarding the method for removing the resist layer 32, ashing can be employed as a dry method, and a removal method using a release solution can be employed as a wet method. Through the ashing process, an original master 36 on which an inversion of a desired concavo-convex pattern is formed is produced.

Subsequently, as shown in FIG. 18G, the surface of the original master 36 is provided with a conductive layer 38 having a uniform thickness. The method for forming the conductive layer 38 can be selected from a variety of metal deposition methods such as sputtering, physical vapor deposition (PVD), chemical vapor deposition (CVD) and ion plating. Provision of one conductive film (indicated by reference numeral 38) enables metal electrodeposition to be uniformly carried out at the next step (electrodepositing step). The conductive layer 38 is preferably a film made mainly of Ni. Such a film can be easily formed and is suitable for a conductive film. The thickness of the conductive layer 38 is not particularly limited and may be generally about several tens nanometers.

Subsequently, as shown in FIG. 18H, a metal plate 40 having a desired thickness is made of metal (Ni in FIG. 18H) over the surface of the original master 36 through electrodeposition (forming step for a plate having an inverted pattern). In this step, the original master 36 is immersed in an electrolytic solution placed in an electrodepositing device, and then an electric current is applied between a cathode and the original master 36 serving as an anode. The concentration of the electrolytic solution, the pH, the manner in which the electric current is applied, etc. are required to be adjusted to attain optimal conditions not causing warp of the metal plate 40 (i.e., a base material 202 as described above with reference to FIG. 8A (master substrate)).

The original master 36 over which the metal plate 40 has been laid in the above manner is removed from the electrolytic solution placed in the electrodepositing device, and then immersed in purified water placed in a releasing bath (not shown).

In the releasing bath, the metal plate 40 is released from the original master 36 (releasing step), to thereby produce a master substrate 42 as shown in FIG. 18I which has a concavo-convex pattern inverted with respect to the pattern of the original master 36.

Next, as shown in FIG. 18J, a magnetic layer 48 (soft magnetic film) is formed on the concavo-convex surface of the master substrate 42. The magnetic layer 48 is made of a material exhibiting magnetic characteristics shown in Table 1. Specific examples of the material include Co₄Pt₁ (atomic ratio). The thickness of the magnetic layer 48 is preferably 10 nm to 320 nm, more preferably 20 nm to 300 nm, still more preferably 40 nm to 100 nm. The magnetic layer 48 is formed through sputtering using the above material.

Thereafter, the master substrate 42 is punched out so as to have a predetermined inner diameter and a predetermined outer diameter. Through the above procedure, a master disc 20 having a concavo-convex pattern is fabricated, which has a magnetic layer 48 (which corresponds to a magnetic layer 204 in FIG. 8A) as shown in FIG. 18J. In the concavo-convex pattern of the thus-fabricated master disc 20, the ratio Sa/La is 1.3 to 1.9, preferably 1.45 to 1.75, where La denotes a width of a convex portion (land portion) in a track direction (circumferential direction), and Sa denotes a width of a concave portion (space portion) in a track direction (circumferential direction).

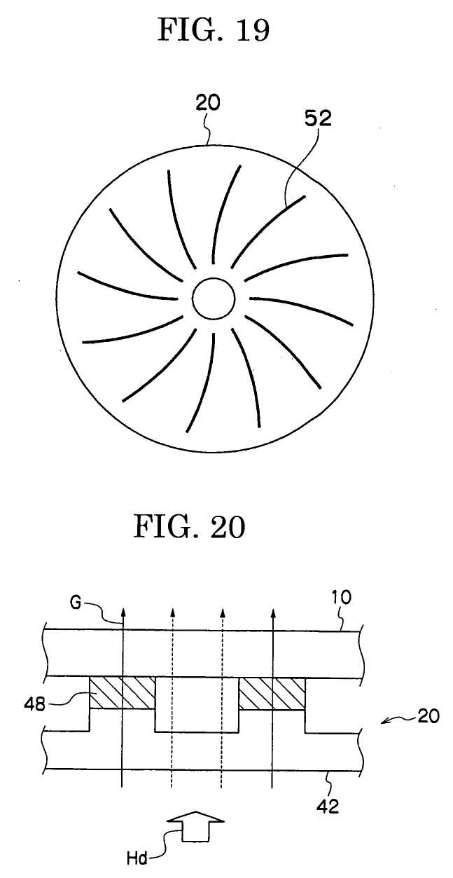

FIG. 19 is a top plan view of the master disc 20. As shown in FIG. 19, a concavo-convex servo pattern 52 is formed in the surface of the master disc 20. Also, unillustrated protective film made, for example, of diamond-like carbon may be formed on the magnetic layer 48 (see FIG. 18J) of the master disc 20. Furthermore, an unillustrated lubricating layer may be formed on the protective film.

When the master disc 20 is closely attached to the slave disc 10, the magnetic layer 48 tends to be scratched. Thus, the protective layer is formed to prevent the master disc 20 from such scratch formation. The lubricating layer prevents, for example, scratch formation by friction generated when the master disc is attached to the slave disc 10 and thus, improves the master disc in durability.

Specifically, a master disc having a preferred layer structure has, on the magnetic layer, a carbon film having a thickness of 2 nm to 30 nm and serving as a protective film, and has a lubricating layer on the protective film. Also, for improving adhesiveness between the magnetic layer 48 and the protective film, an adhesiveness-improving layer made, for example, of Si may be formed on the magnetic layer 48 before formation of the protective film.

### [Closely Attaching Step in Magnetic Transfer]

Next, as shown in FIG. 5B, the master disk 20 is superposed on and closely attached to the slave disk 10 that has been initially magnetized (closely attaching step).

In the closely attaching step in FIG. 5B, using a predetermined pressing force, the surface of the master disk 20 where a protrusion pattern (concavo-convex pattern) has been formed is closely attached to the surface of the slave disk 10 where the magnetic layer 16 has been formed.

If necessary, before closely attached to the master disk 20, the slave disk 10 is subjected to a cleaning process (e.g., burnishing) in which minute protrusions or attached dust on its surface is removed using a grind head, a polisher or the like.

As to the closely attaching step, there is a case where the master disk 20 is closely attached only to one surface of the slave disk 10 as shown in FIG. 5B, and there is another case where master disks are closely attached to both surfaces of a magnetic disk for transfer, with magnetic layers having been formed over both the surfaces. The latter case is advantageous in that transfer for both surfaces can be simultaneously carried out.

### [Magnetic Transfer Step]

Next, the magnetic transfer step will be described with reference to FIG. 5C.

Using an unillustrated magnetic field applying unit, a recording magnetic field Hd is applied, in the opposite direction to the initializing magnetic field Hi, to the slave disk 10 and the master disk 20 that have been closely attached to each other at the closely attaching step. Magnetic transfer is carried out as a magnetic flux generated through formation of the recording magnetic field Hd enters the slave disk 10 and the master disk 20.

In the present embodiment, the intensity of the recording magnetic field Hd is approximately equal to that of He of the magnetic material forming the magnetic layer 16 of the slave disk 10.

As to the magnetic transfer, while the slave disk 10 and the master disk 20 closely attached to each other is being rotated by a rotating unit (not shown), the recording magnetic field Hd is applied by the magnetic field applying unit, to thereby magnetically transfer, to the magnetic layer 16 of the slave disk 10, information recorded on the master disk 20 in the form of the protrusion pattern. In addition to the above, a mechanism of rotating the magnetic field applying unit may be provided such that the magnetic field applying unit is rotated relatively to the slave disk 10 and the master disk 20.

FIG. 20 shows a cross-section of the slave disk 10 and the master disk 20 in the magnetic transfer step. As shown in FIG. 20, when the recording magnetic field Hd is applied with the slave disk 10 being closely attached to the master disk 20 having the concavo-convex pattern, a magnetic flux G becomes strong in a region where the convex portion of the master disk 20 and the slave disk 10 are in contact with each other. The recording magnetic field Hd causes the magnetization direction of a magnetic layer 48 of the master disk 20 to be oriented in the direction thereof. Thus, magnetic information is transferred to the magnetic layer 16 of the slave disk 10. Meanwhile, at the concave portion of the master disk 20, the magnetic flux G generated by the application of the recording magnetic field Hd is weaker than at the convex portion, and the magnetization direction of the magnetic layer 16 of the slave disk 10 does not change, so that the concave portion remains in the initially magnetized state.

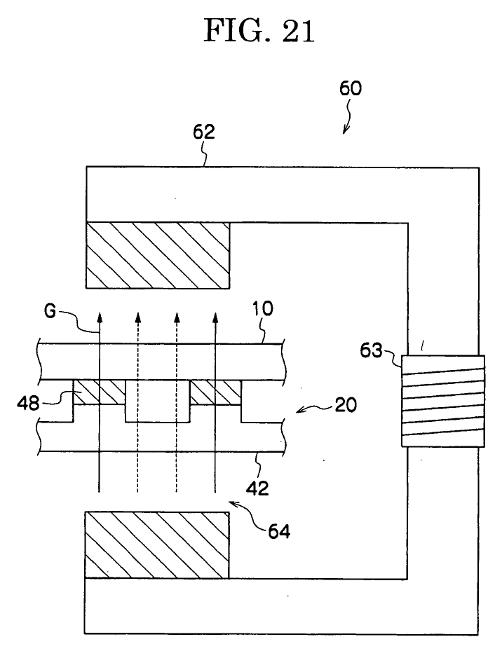

FIG. 21 shows in detail a magnetic transfer apparatus used for magnetic transfer. The magnetic transfer apparatus includes a magnetic field applying unit 60 composed of an electromagnet which is formed by winding a coil 63 around a core 62. By applying an electric current to the coil 63, a magnetic field is generated in a gap 64 perpendicularly to the master disk 20 and the magnetic layer 16 of the slave disk 10. The direction of the magnetic field generated can be changed by changing the direction of the electric current applied to the coil 63. This magnetic transfer apparatus, therefore, makes it possible to initially magnetize the slave disk 10 and also to carry out magnetic transfer.

In the case where this magnetic transfer apparatus is used to carry out initial magnetization and then to carry out magnetic transfer, an electric current is applied which flows in the opposite direction to an electric current applied to the coil 63 of the magnetic field applying unit 60 during initial magnetization. This makes it possible to generate a recording magnetic field in the opposite direction to the magnetization direction at the time of initial magnetization. In the magnetic transfer, while the slave disk 10 and the master disk 20 closely attached to each other is being rotated, the recording magnetic field Hd is applied by the magnetic field applying unit 60, and the information recorded on the master disk 20 in the form of the protrusion pattern is magnetically transferred to the magnetic layer 16 of the slave disk 10; accordingly, the rotating unit (not shown) is provided. Apart from the above, a mechanism of rotating the magnetic field applying unit 60 may be provided such that the magnetic field applying unit 60 is rotated relatively to the slave disk 10 and the master disk 20.

In the present embodiment, magnetic transfer is carried out by applying a recording magnetic field Hd which is equivalent in strength to 60% to 125%, preferably 70% to 115%, of the coercive force Hc of the magnetic layer 16 of the slave disk 10 used in the present embodiment.

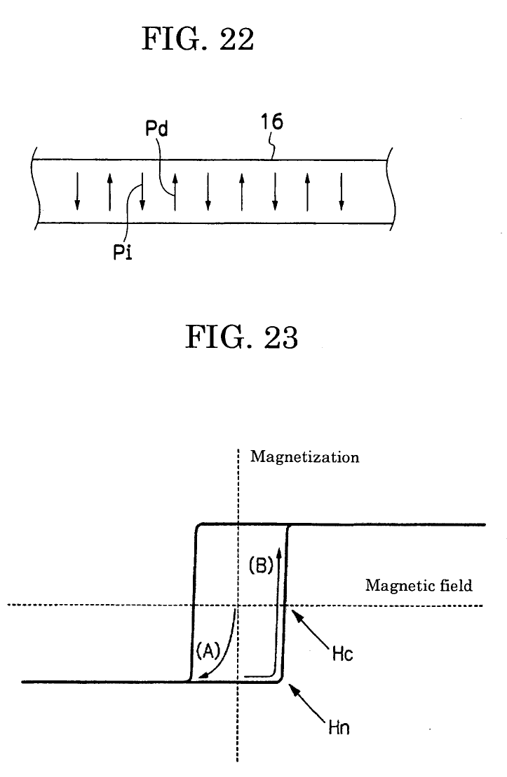

Thus, on the magnetic layer 16 of the slave disk 10, information of a magnetic pattern, such as a servo signal, is recorded as a recording magnetization Pd which is in the opposite direction to the initial magnetization Pi (see FIG. 22).

Notably, the magnetic transfer method of the present invention is carried out, the protrusion pattern of the master disc 20 may be a negative pattern rather than a positive pattern as shown in FIG. 18J. In this case, an initializing magnetic field Hi is applied in a direction opposite to the direction in which the Hi is applied to the master disc having a positive pattern, and also, a recording magnetic field Hd is applied in a direction opposite to the direction in which the Hd is applied to the master disc having a positive pattern, whereby the same magnetic pattern can be magnetically transferred to the magnetic layer 16 of the slave disc 10. Further, an electromagnet serves as the magnetic field applying unit 60 in the present embodiment, but a permanent magnet generating a magnetic field may be used.

[Investigation on Conditions Under which Magnetic Transfer is Carried Out]

FIG. 23 shows a hysteresis curve of a magnetic recording medium, wherein the horizontal axis corresponds to the intensity of an external magnetic field, and the vertical axis corresponds to the intensity of a magnetization.

In the case where information is magnetically transferred to a perpendicular magnetic recording medium based on the concavo-convex pattern formed in the surface of the master disc, when the state where initial magnetization is carried out is expressed by a hysteresis curve in the vicinity of an Mz/Ms of −1 in FIG. 15, a magnetic recording medium is initially magnetized at the initial magnetization step in the direction indicated by arrow A shown in FIG. 23. After the initial magnetization, when closely attached to a master disc for magnetic transfer, the magnetic recording medium is magnetized so as to be along a hysteresis curve extending in the direction indicated by arrow B shown in FIG. 23. As a result, information corresponding to the concavo-convex pattern of the master disc is transferred to the magnetic recording medium.

Also, a perpendicular coercive force (He shown in FIG. 23; i.e., a magnetic field measured when a magnetization is 0) of the perpendicular magnetic recording medium depends semi-logarithmically on time t as shown in the following Equation 1.

Hc(t)=Ha{1−[(kT/KV)ln(At)]ⁿ} <Equation 1>

where Ha denotes an anisotropic magnetic field (Oe); k denotes a Boltzmann constant (1.38×10⁻¹⁶ erg/deg); T denotes a measurement temperature; K denotes an anisotropy constant (erg/cm³); V denotes a magnetization inversion volume (cm³); A denotes a spin precession frequency (2×10⁹ sec⁻¹)/ln2; and n denotes a parameter depending on alignment of moment (½ in general)

Thus, when an external magnetic field is applied to the master disc being closely attached to the magnetic recording medium having undergone initial magnetization, as shown in the above Equation 1, the coercive force He and the reverse magnetic domain nucleus forming magnetic field Hn change depending on a change in magnetic field application time (application speed). Qualitatively, as the application time is shorten (i.e., application speed is increased), the coercive force He and the reverse magnetic domain nucleus forming magnetic field Hn tend to increase.

When the magnetic field application time is too long, both He (coercive force) and Hn (reverse magnetic domain nucleus forming magnetic field) decrease. As a result, a magnetic field in the concave portion of the master disc is greater than Hn, degrading the quality of a transfer signal.

In contrast, when the magnetic field application time is too short, both He (coercive force ) and Hn (reverse magnetic domain nucleus forming magnetic field) increase. As a result, the convex portion of the master disc is not completely magnetized, degrading the quality of a transfer signal In addition, signal quality is also degraded by eddy current formed.

In a perpendicular magnetic recording medium (a medium to which information is to be transferred) which gives a hysteresis curve as shown in FIG. 17, when the following Expression 2 is satisfied, an ideal reproduction signal waveform can be obtained.

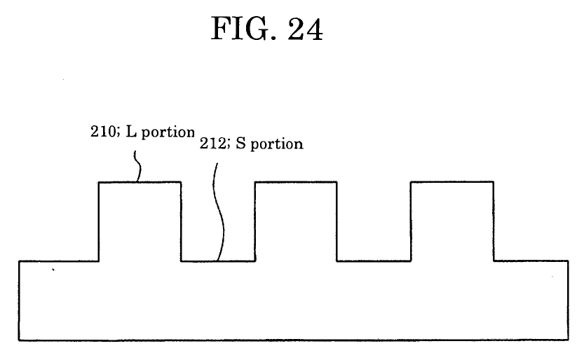

2×(Hc−Hn)<(magnetic field in L portion of master)−(magnetic field in S portion of master) <Expression 2>

where “L portion” is a surface (land) of the convex portion 210 in the concavo-convex pattern of the master disc 20 (see FIG. 24), and “S portion” is a surface (space) of the concave portion 212 (groove) in the concavo-convex pattern of the master disc 20 (see FIG. 24).

In magnetic transfer, a slave disc is magnetized using a master disc having a difference in magnetic field between the concave and convex portions. This difference brought by the concavo-convex pattern is determined to some extent the design of the pattern. But, as described above, the hysteresis curve depends on time and thus, Hc and Hn change depending on a change in application time of an external magnetic field. Specifically, even when magnetic fields in the L and S portions are each constant, in the perpendicular magnetic recording medium, the difference between the magnetization quantity brought by the magnetic field in the L portion and that brought by the magnetic field in the S portion changes depending on a change in magnetic field application time.

In view of this, in an embodiment of the present invention, the application time of a DC magnetic field is optimized to maximize the difference between the magnetization quantity brought by the magnetic field in the L portion and that brought by the magnetic field in the S portion.

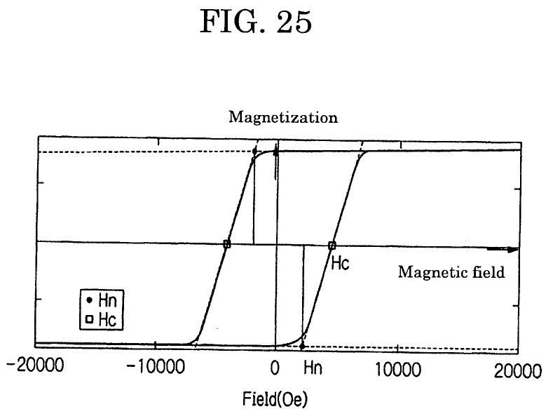

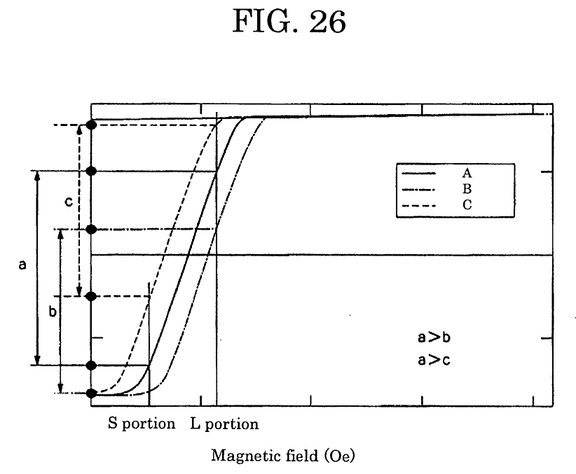

FIG. 26 is a graph of three different hysteresis curves corresponding to three different magnetic field application times, and show only the first and fourth quadrants of FIG. 25 (i.e., a region where a magnetic field is a positive value). When the magnetic field application time is too short, a curve drawn by a dashed line in FIG. 26 is given. In this case, both Hc and Hn increase, and “b” indicates the difference, in the perpendicular magnetic recording medium, between the magnetization quantity brought by the magnetic field in the L portion and that brought by the magnetic field in the S portion.

In contrast, when the magnetic field application time is too long, a curve drawn by a dotted line in FIG. 26 is given. In this case, both He and Hn decrease, and “c” indicates the difference, in the perpendicular magnetic recording medium, between the magnetization quantity brought by the magnetic field in the L portion and that brought by the magnetic field in the S portion.

When the magnetic field application time is optimized (i.e., the magnetic field application speed is optimized), a curve drawn by a solid line in FIG. 26 is given. In this case, “a” indicates the difference, in the perpendicular magnetic recording medium, between the magnetization quantity brought by the magnetic field in the L portion and that brought by the magnetic field in the S portion, and is greater than “b” or “c” as shown in FIG. 26.

As used herein, “the difference between the magnetization quantity brought by the magnetic field in the L portion and that brought by the magnetic field in the S portion” (indicated by “a,” “b” or “c” in FIG. 26) is a value obtained when the external magnetic field for each of the L and S portions is returned to “0” so as to be along a minor loop after termination of application thereof.

As described above, an optimally-adjusted magnetic field application time attains, in the medium, a large difference between the magnetization quantity brought by the magnetic field in the L portion and that brought by the magnetic field in the S portion, improving the quality of the waveform of a transfer signal to be read (e.g., achieving a great output value and/or a constant width of the waveform).

A perpendicular magnetic recording medium obtained by the above-described method according to an embodiment of the present invention is mounted in use to, for example, a magnetic recording/reproducing device such as hard disc devices, and can provide a high recording density magnetic recording/reproducing device having high servo accuracy and preferred recording/reproducing characteristics.

### EXAMPLES

The present invention will next be described by way of examples, which should not be construed as limiting the present invention thereto.

### Example 1 and Comparative Example 1

Using a magnetic transfer master carrier having perpendicular magnetic anisotropy in the present invention (the master carrier having a magnetic layer with a residual magnetization Mr of 500 emu/cc and a saturation magnetization Ms of 900 emu/cc, and having a magnetic layer-covered transfer portion corresponding to magnetic information and a concave non-transfer portion lower in height than the transfer portion) (Example 1) and a magnetic transfer master carrier having a conventional magnetic layer (having no perpendicular magnetic anisotropy) (Comparative Example 1), the relationship between the magnetic field application time and the quality of the waveform of a reproduced signal (transferring performance) was investigated. The results are shown in Table 2.

The slave disc used in the experiments had a coercive force He of 4,000 [Oe]. After initial magnetization, the slave disc was closely attached to a master disc having a concavo-convex pattern radially formed from 50 nm to 300 nm in a circumferential direction and 50 nm to 300 nm in a radial direction. In this state, a DC magnetic field was applied perpendicularly to the disc surface while the application time thereof was being changed from 1 ns (nano second) to 1,000 s (second), whereby information corresponding to the concavo-convex pattern was magnetically transferred to the slave disc. The information of the thus-obtained slave disc was reproduced for evaluation of the waveform of a reproduced signal output.

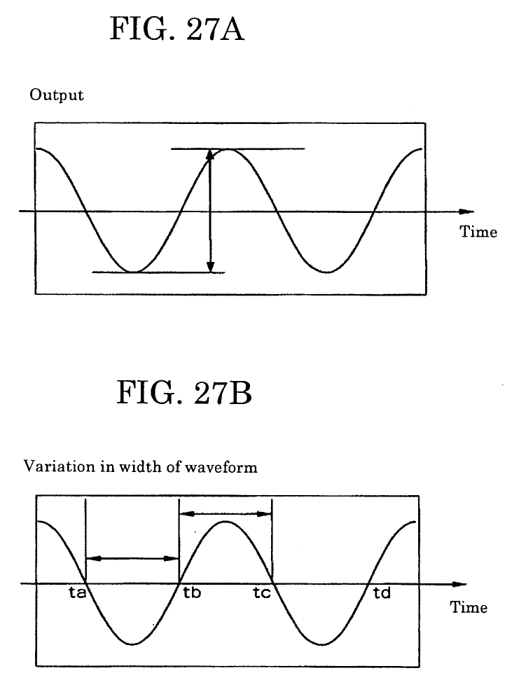

As shown in FIGS. 27A and 27B, evaluation was carried out in terms of reproduced signal outputs (double amplitudes) and variation in width of a waveform (width with time). The output values were normalized by an output value measured at a magnetic field application time of 1 sec. The greater the output value, the higher the signal quality. Meanwhile, the variation was obtained as follows. First, the times (ta, tb, tc, td, . . . ) (zero cross points), as shown in FIG. 27B, at which a waveform to be evaluated crossed with the axis of time are determined. As is clear from FIG. 27B, ranges of ta to tb, tb to tc, tc to td, . . . were each the widths of the waveform (corresponding to ½ pulse) and thus, the standard deviation of the ranges was determined and defined as “variation in width of a waveform.” The smaller the variation, the higher the signal quality.

Next will be described an apparatus used for evaluating a servo signal transferred to the slave disc.

The slave disc is fixed by the axis of a spindle motor so as to be rotated at a predetermined speed (revolution). A magnetic head is disposed proximately to the slave disc surface at a predetermined flying height. The magnetic head can be moved by a positioner to a predetermined position, and is used for recording/reproducing.

Also, a synchroscope (oscilloscope) is connected to the magnetic head, and displays the waveform of a signal read by the magnetic head. The synchroscope is also connected to the spindle motor, and an index signal, which is output when the rotator of the spindle motor is in a predetermined rotation angle, is input as a trigger signal to the synchroscope.

TABLE 2

| | Example 1 | | Comparative Example 1 | |
|---|---|---|---|---|
| | Output value | | Output value | |
| | normalized by a | Variation in width | normalized by a | Variation in width |
| Magnetic field | value at 1 sec | of waveform % | value at 1 sec | of waveform % |
| application time | (greater value | (smaller value | (greater value | (smaller value |
| (sec) | preferred) | preferred) | preferred) | preferred) |
| 0.000000001 | 1.20 | 0.80 | 0.80 | 0.85 |
| 0.00000001 | 1.31 | 0.77 | 0.90 | 0.80 |
| 0.0000001 | 1.41 | 0.65 | 1.00 | 0.70 |
| 0.000001 | 1.52 | 0.63 | 1.10 | 0.67 |
| 0.00001 | 1.62 | 0.60 | 1.20 | 0.65 |
| 0.0001 | 1.73 | 0.57 | 1.30 | 0.63 |
| 0.001 | 1.83 | 0.55 | 1.40 | 0.62 |
| 0.01 | 1.73 | 0.63 | 1.30 | 0.66 |
| 0.1 | 1.52 | 0.65 | 1.10 | 0.68 |
| 1 | 1.41 | 0.68 | 1.00 | 0.70 |
| 10 | 1.36 | 0.73 | 0.95 | 0.80 |
| 100 | 1.31 | 0.80 | 0.90 | 0.85 |
| 1,000 | 1.30 | 0.85 | 0.90 | 0.90 |

As is clear from Table 2, when the transfer magnetic field application time was varied, the magnetic transfer master carrier having a perpendicularly magnetized film (Example 1) was found to exhibit, at any transfer magnetic field application times, higher reproduced signal outputs and smaller variation in width of a waveform than the magnetic transfer master carrier having a conventional magnetic film (Comparative Example 1). Thus, the master carrier of Example 1 was found to give better signal quality.

In Example 1, first, the output value gradually increased in accordance with increasing of the magnetic field application time, and was the maximum value “1.83” at an application time of 0.001 ms. At application times of 0.01, 0.1, 1, 10, 100 and 1,000, the output value decreased in accordance with increasing of the magnetic field application time.

Meanwhile, first, the variation in width of a waveform was gradually smaller in accordance with increasing of the magnetic field application time, and was the minimum value “0.55” at an application time of 0.001 ms. At application times of 0.01, 0.1, 1, 10, 100 and 1,000, the variation was larger in accordance with increasing of the magnetic field application time. Comprehensively judging from the output value and the variation, the magnetic field application time is preferably 100 ns to 1 sec, more preferably 1 μs to 100 ms, still more preferably 100 μs to 10 ms.

When a magnetic field is applied at an application time falling within the above range, the quality of transfer signals can be improved.

Strictly speaking, different magnetic materials have different characteristics (hysteresis curve and time dependency thereof). But, known materials used in the perpendicular magnetic recording medium generally show almost the same results as given above. Thus, an optimal magnetic field application time falls within the above range.

The perpendicular magnetic recording medium obtained by the present magnetic transfer method for a magnetic recording medium is mounted in use to, for example, a magnetic recording/reproducing device such as a hard disc device, and can provide a high recording density magnetic recording/reproducing device having high servo accuracy and preferred recording/reproducing characteristics.

What is claimed is:

1. A magnetic transfer method for a magnetic recording medium, in which method magnetic information is recorded on a perpendicular magnetic recording medium through magnetic transfer, the method comprising.
initially magnetizing a perpendicular magnetic recording medium by applying a DC magnetic field thereto in a perpendicular direction, and
applying, to the perpendicular magnetic recording medium, a DC magnetic field for 100 nsec to 1 see in an opposite direction to the magnetic field applied in initial magnetization with the recording medium being closely attached to a magnetic transfer master carrier which transfers magnetic information to the recording medium with being brought into contact with the recording medium,
wherein the master carrier comprises transfer portions on which surfaces a magnetic layer corresponding to magnetic information is laid, and non-transfer portions which are concave portions lower in height than the transfer portions, and
wherein the magnetic layer has perpendicular magnetic anisotropy and has a residual magnetization Mr of 500 emu/cc or lower and a saturation magnetization Ms of 900 emu/cc or higher.

2. The magnetic transfer method according to claim 1, wherein the magnetic layer of the master carrier is made of CoPt.

3. The magnetic transfer method according to claim 1, wherein the magnetic layer of the master carrier is made of Co₄Pt₁ (atomic ratio).

4. The magnetic transfer method according to claim 1, wherein the master carrier further comprises an underlying layer under the magnetic layer, and the underlying layer is made of CoCr, Ru, Pt, or a combination thereof.

5. The magnetic transfer method according to claim 1, wherein the magnetic layer is laid only on the transfer portions, and the transfer portions with the magnetic layer laid on surfaces thereof are more protruded by the thickness of the magnetic layer than the non-transfer portions.

6. The magnetic transfer method according to claim 1, wherein the perpendicular magnetic recording medium has a coercive force Hc of 4,000 Oe or higher.

7. A magnetic recording medium obtained by a method comprising:
initially magnetizing a perpendicular magnetic recording medium by applying a DC magnetic field thereto in a perpendicular direction,
applying, to the perpendicular magnetic recording medium, a DC magnetic field for 100 nsec to 1 sec in an opposite direction to the magnetic field applied in initial magnetization with the recording medium being closely attached to a magnetic transfer master carrier which transfers magnetic information to the recording medium with being brought into contact with the recording medium,
wherein the master carrier comprises transfer portions on which surfaces a magnetic layer corresponding to magnetic information is laid, and non-transfer portions which are concave portions lower in height than the transfer portions, and
wherein the magnetic layer has perpendicular magnetic anisotropy and has a residual magnetization Mr of 500 emu/cc or lower and a saturation magnetization Ms of 900 emu/cc or higher.
